(19) United States
(12) Patent Application Publication
(10) Pub. No.: US 2025/0140967 A1
(43) Pub. Date: May 1, 2025

(54) BATTERY SYSTEM WITH CELL SPACERS BETWEEN BATTERY CELLS AND A METHOD OF MANUFACTURING THEREOF

(71) Applicant: SAMSUNG SDI CO., LTD., Yongin-si (KR)

(72) Inventors: Bernhard HADLER, Feldkirchen bei Graz (AT); Luigi AIELLO, Graz (AT)

(21) Appl. No.: 18/616,501

(22) Filed: Mar. 26, 2024

(30) Foreign Application Priority Data
Oct. 26, 2023 (EP) 23206184.6

(51) Int. Cl. H01M 10/6551; H01M 10/04; H01M 10/613; H01M 10/653; H01M 10/6554; H01M 50/209; H01M 50/249; H01M 50/293

(52) U.S. Cl. CPC H01M 10/6551; H01M 10/0481; H01M 10/613; H01M 10/653; H01M 10/6554; H01M 50/209; H01M 50/249; H01M 50/293; H01M 2220/20

(57) ABSTRACT

A battery system includes: a first battery cell and a second battery cell; a housing accommodating the first and second battery cells; a cell spacer between the first battery cell and the second battery cell; a gap filler layer having a first surface facing the first and second battery cells and a second surface facing away from the first and second battery cells; and a cooling plate having a surface contacting the second surface of the gap filler layer. The first and second battery cells contact the first surface of the gap filler layer. The cell spacer includes a first insulating layer, a second insulating layer, and a metal fin between the first insulating layer and the second insulating layer, and the metal fin at least partially penetrates the gap filler layer so that an end portion of the metal fin extends toward the cooling plate.

### CROSS-REFERENCE TO RELATED APPLICATION

The present application claims priority to and the benefit of European Patent Application No. 23206184.6, filed on Oct. 26, 2023, in the European Patent Property Office, the entire disclosure of which is incorporated herein by reference.

### BACKGROUND

### 1. Field

Aspects of embodiments of the present disclosure relate to a battery system including cell spacers between battery cells, a method of manufacturing the battery system, and a vehicle including the battery system.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

Related art battery systems, despite any modular structure, usually include a battery housing that acts as enclosure to seal the battery system against the environment and provides structural protection of the battery system's components. Housed battery systems are usually mounted as a whole into their application environment, such as an electric vehicle.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result.

In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway.

The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

In battery systems, cell spacers are used to prevent a spread of thermal runaway across the battery cells of the battery system. Cell spacers, including thermally insulating spacers, between the battery cells act as cell-to-cell thermal barriers. Thus, critical overheating in one battery cell from among the plurality of battery cells may not spread (or may be prevented from spreading) to other battery cells due to the presence of the cell spacer therebetween. Thus, a thermal runaway event is more likely to remain localized.

In addition, when a battery cell undergoes thermal runaway or emits heat for any reason, the heat should be removed to prevent damage to components of the battery system and to prevent heat spread. Therefore, heat needs to be locally dissipated to cool the battery cell to avoid or stop thermal runaway. For this purpose, a cooling plate and a thermally conductive gap filler, which allows heat to conducted through the gap filler to the cooling plate, acting as a heat sink to receive at least a part of the heat may be provided.

However, despite the gap filler having some thermal conductivity property, the thermal conduction from the battery cell to the cooling plate via the gap filler remains limited. Therefore, in particular cases, heat flow to the cooling plate may not be sufficiently fast to stop or prevent spreading of thermal runaway in the battery system.

### SUMMARY

The present disclosure is defined by the appended claims. Any disclosure lying outside the scope of the claims is intended for illustrative as well as comparative purposes.

According to one embodiment of the present disclosure, a battery system includes: a first battery cell and a second battery cell; a housing accommodating the first and second battery cells; a cell spacer between the first battery cell and the second battery cell; a gap filler layer having a first surface facing the first and second battery cells and a second surface facing away from the first and second battery cells; and a cooling plate having a surface contacting the second surface of the gap filler layer. The cell spacer includes a first insulating layer, a second insulating layer, and a metal fin between the first insulating layer and the second insulating layer. The first and second battery cells are in contact with the first surface of the gap filler layer, and the metal fin at least partially penetrates the gap filler layer so that an end portion of the metal fin extends toward the cooling plate.

According to another embodiment of the present disclosure, a method of manufacturing a battery system is provided. The method includes pressing the metal fin onto the gap filler layer until the metal fin at least partially penetrates the gap filler layer so that the end portion of the metal fin extends toward the cooling plate.

Another embodiment of the present disclosure provides a vehicle including the above-described battery system.

Further aspects and features of the present disclosure can be learned from the disclosure that follows, the drawings, and the claims.

### BRIEF DESCRIPTION OF THE DRAWINGS

Aspects and features of the present disclosure will become more apparent to those of ordinary skill in the art by describing, in detail, embodiments thereof with reference to the attached drawings, in which:

FIG. 1 is a schematic side view of a battery system according to an embodiment,

FIGS. 2A and 2B illustrate steps of a method of manufacturing a battery system according to an embodiment, and

FIG. 3 is a schematic side view of a battery system according to another embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Herein, the terms “upper” and “lower” are defined according to the z-axis in the drawings. For example, the upper cover is positioned at the upper part of the z-axis, and the lower cover is positioned at the lower part thereof. In the drawings, the sizes of elements may be exaggerated for clarity. For example, in the drawings, the size or thickness of each element may be arbitrarily shown for illustrative purposes, and thus, the embodiments of the present disclosure should not be construed as being limited thereto. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a plurality of battery cells. The plurality of battery cells includes a first battery cell and a second battery cell. The battery cells are accommodated in a battery housing. The battery system includes a plurality of cell spacers including a cell spacer positioned between the first battery cell and the second battery cell. The cell spacer includes a first (thermally) insulating layer, a second (thermally) insulating layer, and a metal fin between the first insulating layer and the second insulating layer. The battery system further includes a gap filler having a first surface facing the plurality of battery cells and a second surface facing away from the plurality of battery cells. The battery cells are in contact with the first surface of the gap filler. The battery system further includes a cooling plate having a surface in contact with the second surface of the gap filler layer. Further, the metal fin of the cell spacer at least partially penetrates, extends into, or is immersed in the gap filler so that an end portion of the metal fin extends toward the cooling plate.

The gap filler may also be referred to as a gap filler layer. The gap filler may be a thermally conductive cured liquid material. The gap filler may be a thermally conductive paste material. The gap filler may also be referred to as a thermal interface material (TIM) layer. The metal fin may be metal plate. Metal has a relatively high thermal conductivity. The surfaces of the gap filler may also be referred to as contact surfaces. Further, metal generally has relatively high rigidity. The metal may be aluminum or copper but the present disclosure is not restricted thereto. The thermal conductivity of the metal may be higher than the thermal conductivity of the gap filler material. That is, even though the gap filler material is thermally conductive (e.g., has a thermal conductance), the heat conductivity of the gap filler is lower than the heat conductivity of the metal material of the metal fin. The cell spacer, having the first and second insulating layer, acts as thermal barrier between the first and second battery cell. The insulating layers may cover and/or contact a side surface of the corresponding battery cell so that the metal fin is thermally (and electrically) insulated from the battery cells. Thus, the cell spacer may act as cell-to-cell thermal barrier. That the metal fin of the cell spacer at least partially penetrates the gap filler so that an end portion of the metal fin extends toward the cooling plate may mean, in other words, that the metal fin at least approaches the cooling plate by remaining above the cooling plate. To term penetrate may mean, in other words, that it at least partially extends into or is immersed or embedded in the gap filler layer.

The metal fin, due to its at least partial penetration of the gap filler layer, provides a heat conducting path directed to the cooling plate to rapidly dissipate excess heat along the metal to the cooling plate (which acts as heat sink). Because the thermal conductivity of the gap filler layer is limited, heat can be thermally conducted through the end portion of the metal fin to the cooling plate in faster manner than compared to when the heat has to propagate through the bulk (e.g., thickness) of the gap filler layer. Thus, the cell spacer not only acts as thermal barrier between the (first and second) battery cells but also provides a fast heat dissipation path to rapidly remove heat to the cooling plate without affecting the cell-to-cell thermal insulation. Therefore, a thermal runaway is more likely to be stopped or prevented in the provided battery system.

According to an embodiment, the end portion of the metal fin protrudes with respect to (or protrudes from) the first and second insulating layers in a direction toward the cooling plate. Because the end portion of the metal fin protrudes from (or protrudes beyond) the surfaces of the insulating layers, the at least partial penetration of the gap filler layer can be performed easily during a step of pressing only the protruding end portion of the metal fin on the gap filler layer using the rigidity of the metal to cause the at least partial penetration. Thus, part of the gap filler layer can be displaced by the metal fin.

According to an embodiment, the first insulating layer and the second insulating layer are, respectively, surfaces directed toward the cooling plate, and the surfaces of the first insulating layer and the second insulating layer contact the first surface of the gap filler layer without penetrating the gap filler layer. Thus, because the end portion of the metal fin protrudes from the insulating layers, heat is not only conducted in the main direction of the metal fin but is also conducted in side conduction paths provided from the (free) sides of the protruding end portion toward the cooling plate. This may also help to distribute the heat flow from the metal fin to the coolant plate to maintain a heat gradient.

According to one embodiment, the end portion of the metal fin penetrates the gap filler by at least about 50%, about 70%, or about 90% of a thickness of the gap filler layer in a direction toward the cooling plate. When the end portion of the metal fin penetrates the gap filler layer by more than about 50%, a substantial increase in heat conductance is provided because heat has to penetrate less than half of the gap filler layer thickness to reach the cooling plate. Thus, a rapid heat conduction link (or path) is provided. The end portion of the metal fin may penetrate the gap filler layer by more than about 90% of the thickness of the gap filler layer. Then, the metal fin is nearly in (direct) contact with the cooling plate so that heat conductance to the cooling plate is maximized.

According to one embodiment, a first distance from an end portion of the metal fin to the surface of the cooling plate is less than about 0.5 mm, less than about 0.3 mm, or about 0.1 mm. Thus, when the first distance of the end portion of the metal fin to the surface of the cooling plate is less than about 0.5 mm, the heat conductance to the cooling plate is increased. For example, when the first distance from the end portion of the metal fin to the surface of the cooling plate is less than about 0.1 mm, the heat conductance to the cooling plate is substantially increased or maximized.

According to one embodiment, the first insulating layer and/or the second insulating layer include silica aerogel. Silica aerogel may be a solid foam including silica having high porosity. The aerogel is light weight and exhibits low heat conductance. Thus, an efficient and light-weight thermal cell-to-cell insulation can be provided.

According to one embodiment, the end portion of the metal fin has side surfaces that contact side surfaces of the gap filler layer. Thus, because the end portion of the metal fin contacts the side surface of the gap filler layer, heat is not only conducted in the main direction of the metal fin but also propagates in side conduction paths provided by the side contacts.

According to one embodiment, the end portion of the metal fin is spatially separated from the surface of the cooling plate by a separation layer of the gap filler layer. The separation layer may be a residual layer resulting from producing the tight contact due to pressing the metal fin into the gap filler layer. This residual separation layer is small compared the height of the gap filler layer so that heat can easily be conducted across the separation layer from the metal fin to the cooling plate.

According to another embodiment, the first insulating layer and/or the second insulating layer include Mica. Mica is a mineral with good thermal insulation properties. Thus, an efficient thermal cell-to-cell insulation can be provided.

According to one embodiment, a first distance from the end portion of the metal fin to the cooling plate is shorter than a second distance from the end portion to the first or second battery cell to the cooling plate. This arrangement provides relatively high cell-to-cell thermal insulation by providing a relatively larger second distance (e.g., a greater thickness of thermal insulation layer) while allowing enhanced heat dissipation toward the cooling plate by having a relatively small first distance.

According to one embodiment, the plurality of battery cells are prismatic battery cells. The geometry of prismatic cells is particularly suitable for stacking the battery cells. Thus, the cell spacer technology is useful for the prismatic battery cells, but the present disclosure is not limited to prismatic battery cells.

According to an embodiment, the end portion of the metal fin directly contact the surface of the cooling plate. Due to the direct contact, heat conductance along the metal fin toward the cooling plate is maximized. This configuration may be achieved by processing the gap filler layer differently (e.g., by etching) instead of the pressing step in which an entire removal (e.g., removal of the residual separation layer) may not be feasible.

According to another embodiment of the present disclosure, a method of manufacturing a battery system according to one or more of the above embodiments is provided. The method includes a step of pressing the metal fin onto (or into) the gap filler layer until the metal fin at least partially penetrates the gap filler layer so that the end portion of the metal fin extends toward the cooling plate. Thus, a relatively fast and simple assembly process is provided. The rigidity of the metal fin compared to the gap filler material provides the at least partial penetration. A portion of the gap filler material is thereby displaced in response to the pressing. Thus, the gap filler material makes space for the end portion of the metal fin (e.g., a space is formed in the gap filler material for the metal fin). The penetration due to the pressing may also support the metal fin in the gap filler layer.

According to one embodiment, the method further includes a step of providing the cell spacer prior to the step of pressing by connecting the first insulating layer and the second insulating layer with the metal fin such that the end portion of the metal fin protrudes with respect to (e.g., protrudes beyond) end portions of the first and second insulating layers. Thus, the rigid end portion of the metal fin can be used to displace the gap filler layer material to provide the close contact.

According to one embodiment, the step of pressing is performed such that end portions of the first insulating layer and the second insulating layer contact the first surface of the gap filler layer without penetrating the gap filler layer. This may provide a tight connection and allows maximum heat conductance to the cooling plate. Additionally, the insulating layers do not interfere in the pressing step as this pressing is then only performed by the end portion of the metal fin.

Further method steps can be derived from the above features of the battery system.

According to another embodiment of the present disclosure, a vehicle includes the battery system according to one or more of the above embodiments.

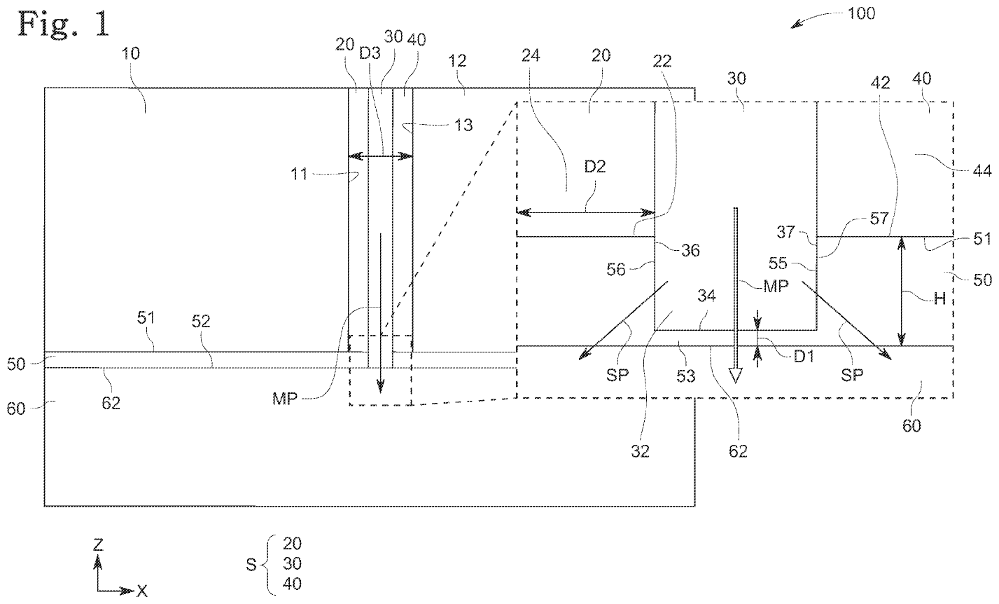

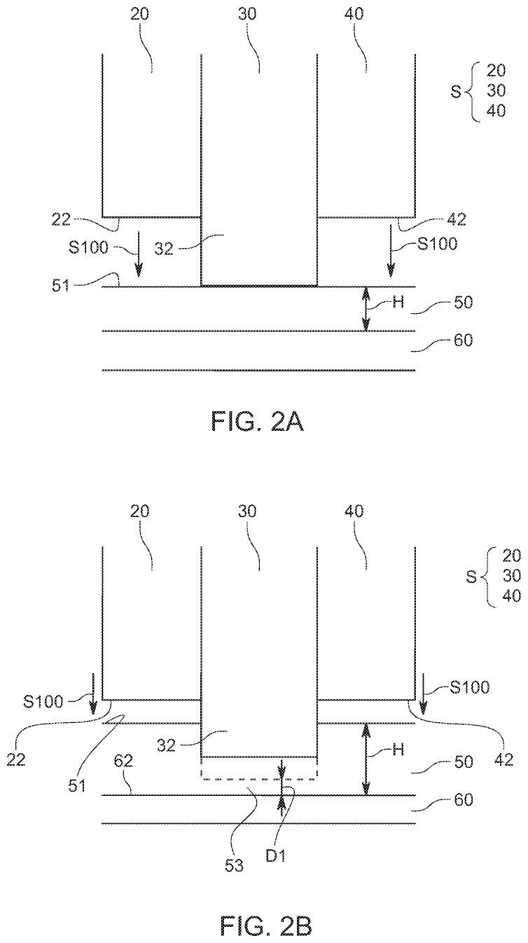

FIG. 1 is a schematic side view of a battery system 100 according to an embodiment and includes an enlarged part of the battery system 100. FIGS. 2A and 2B illustrate steps of a method of manufacturing a battery system 100 according to an embodiment.

The battery system 100 includes a plurality of battery cells 10, 12. The battery cells 10, 12 are accommodated in a housing. The number of battery cells 10, 12 is not limited to a particular number. The battery cells 10, 12 may be arranged in a predefined manner (or alignment) to be efficiently packed. The battery cells 10, 12 or subsets thereof may be electrically interconnected with each other to provide a common output or input.

Because embodiments of the present disclosure primarily relate to an interface between two battery cells 10, 12, a first battery cell 10 and a second battery cell 12 are shown in FIG. 1. However, the battery cells 10, 12 may be part of a larger set of battery cells 10, 12. Further, various compartments may be provided to support the plurality of battery cells 10, 12 including the first battery cell 10 and the second battery cell 12. In the following description, the interface between the first battery cell 10 and the second battery cell 12 will be described in more detail.

The battery system 100 includes a plurality of cell spacers S. Referring to FIG. 1, a cell spacer S is positioned between the first battery cell 10 and the second battery cell 12. The cell spacer S forms a thermal barrier between the first battery cell 10 and the second battery cell 12 to prevent heat propagation between the first battery cell 10 and the second battery cell 12. In the illustrated embodiment, the plurality of battery cells 10, 12 are prismatic battery cells 10, 12, between which the cell spacers S are provided. However, the present disclosure is not limited thereto and the battery cells 10, 12 can have various forms.

According to embodiments of the present disclosure, the cell spacer S includes a first insulating layer (e.g., a first thermally insulating layer) 20, a second layer (e.g., a second thermally insulating layer) 40, and a metal fin 30. The metal fin 30 is positioned between the first insulating layer 20 and the second insulating layer 40, as shown in FIG. 1. Thus, the metal fin 30 is sandwiched by the first insulating layer 20 and the second insulating layer 40.

The first insulating layer 20 may extend along a side surface 11 of the first battery cell 10. The second insulating layer 40 may extend along a side surface 13 of the second battery cell 12. Thus, due to the first insulating layer 20 and the second insulating layer 40, thermal conductance between the first battery cell 10 and the second battery cell 12 is reduced. If one from among the first battery cell 10 and the second battery cell 12 undergoes thermal runaway or overheats, excessive heat cannot easily propagate to the other one from among the first battery cell 10 and the second battery cell 12 so that cell-to-cell thermal insulation is provided despite the presence of the metal fin 30.

To prevent or reduce cell-to-cell heat propagation, in some embodiments, the first insulating layer 20 and/or the second insulating layer 40 may include silica aerogel. Silica aerogel has good insulating properties and is light weight due to its high porosity. In other embodiments, the first insulating layer 20 and/or the second insulating layer 40 may include Mica. Mica has excellent heat insulation properties to effectively prevent cell-to-cell heat propagation.

The battery system 100 further includes a gap filler layer 50. The battery cells 10, 12 may be disposed on the gap filler layer 50 and may contact the gap filler layer 50, as shown in FIG. 1. Thus, the battery cells 10, 12 are supported by the gap filler layer 50. The gap filler layer 50 has a first surface 51 facing the plurality of battery cells 10, 12 and a second surface 52 facing away from the plurality of battery cells 10, 12. As shown in FIG. 1, the plurality of battery cells 10, 12 may be in contact with the first surface 51 of the gap filler layer 50.

The battery system 100 further includes a cooling plate 60 disposed below the gap filler layer 50. A surface 62 of the cooling plate 60 contacts the second surface 52 of the gap filler layer 50. The gap filler layer 50 has limited thermally conductive properties but may conduct heat according to a certain level to the cooling plate 60.

Referring to FIG. 1 and, in particular, to the enlarged part of FIG. 1, the metal fin 30 of the cell spacer S at least partially penetrates (e.g., extends into) the gap filler layer 50. The metal fin 30 penetrates the gap filler layer 50 such that an end portion 32 of the metal fin 30 extends toward the cooling plate 60. Thus, the metal fin 30 is closer to the cooling plate 60 than the first surface 51 of the gap filler layer 50 is such that the travel path of heat through the gap filler layer 50 is reduced and heat can be more easily conducted from the end portion 32 of the metal fin 30 to the cooling plate 60.

Due to the at least partial penetration of the metal fin 30 through the gap filler layer 50, a main heat conducting path MP along the metal fin 30 toward the cooling plate 60 is provided for rapid heat dissipation via the metal fin 30 (e.g., via the end portion 32) to the cooling plate 60, which acts as heat sink, as shown by the arrow in FIG. 1.

Because the thermal conductivity of the gap filler layer 50 is limited, thermal conduction to the cooling plate 60 is improved (or is facilitated) via the end portion 32 of the metal fin 30 to the cooling plate 60 compared to when heat has to propagate through the bulk (e.g., the thickness or the entire thickness) of the gap filler layer 50. Therefore, the cell spacer S not only acts as thermal barrier between the first and second battery cells 10, 12 due to the insulating layers 20, 40 but also provides a fast heat dissipation path (e.g., the main heat conducting path MP) for heat to be rapidly dissipated to the cooling plate 60. Thus, a thermal runaway is more likely to be stopped or avoided due to the presence of the metal fin 30 at least partially penetrating the gap filler layer 50.

The cell spacer S has a geometrical structure as described below. The first insulating layer 20 and the second insulating layer 40 respectively have surfaces 22, 42. These surfaces 22, 42 are directed toward (e.g., face or contact) the gap filler layer 50 (or the cooling plate 60). The end portion 32 of the metal fin 30 protrudes with respect to (or protrudes beyond) end portions 24, 44 of the first and second insulating layers 20, 40 in a direction toward the cooling plate 60. Thus, the metal fin 30 extends toward the cooling plate 60 through (or partially through) the gap filler layer 50. Further, the surfaces 22, 42 of the first insulating layer 20 and the second insulating layer 40 contact the first surface 51 of the gap filler layer 50 without penetrating the gap filler layer 50. Thus, because the end portion 32 of the metal fin 30 protrudes from the insulating layers 20, 40, heat is not only conducted along the main heat conducting path MP but is also conducted along side heat conduction paths SP formed by the (free) sides of the protruding end portion 32, as shown in FIG. 1, which may help to more quickly distribute and absorb heat to or from the cooling plate 60.

In the embodiment shown in FIG. 1, the end portion 32 of the metal fin 30 penetrates about 90% of a thickness H of the gap filler layer 50. In other embodiments, the end portion 32 may penetrate the thickness H of the gap filler layer 50 at least by about 50%, at least by about 70%, or at least by about 90% of the thickness H of the gap filler layer 50 in a direction toward the cooling plate 60. When the end portion 32 of the metal fin 30 penetrates the gap filler layer 50 by more than about 50%, a substantial increase of heat conductance is achieved. When the end portion 32 of the metal fin 30 penetrates the gap filler layer 50 by more than about 90%, as shown in FIG. 1, the metal fin 30 is nearly in (direct) contact with the cooling plate 60 so that heat conductance to the cooling plate 60 is substantially increased or maximized.

The distance from the end portion 32 of the metal fin 30 to the cooling plate 60 is a first distance D1. The first distance D1, which is from a bottom surface 34 of the end portion 32 of the metal fin 30 to the surface 62 of the cooling plate 60, is about 0.1 mm and the total thickness H of the gap filler layer 50 is about 1.0 mm. In other embodiments, the first distance D1 from the end portion 32 of the metal fin 30 to the surface 62 of the cooling plate 60 may be at least less than about 0.5 mm, at least less than about 0.3 mm, or at least less than about 0.1 mm. These short first distances D1 between the cooling plate 60 and the metal fin 30 may allow for rapid heat dissipation through the end portion 32 of the metal fin 30.

In the embodiment shown in FIG. 1, the end portion 32 of the metal fin 30 is spatially separated from the surface 62 of the cooling plate 60 through a separation layer 53 of the gap filler layer 50. This can be the result of production tolerance during a method of pressing the metal fin 30 toward the cooling plate 60. However, because the separation layer 53 may be thin (e.g., having the first distance D1) compared to the total thickness H of the gap filler layer 50, heat can be easily conducted from the metal fin 30 to the cooling plate 60 across the separation layer 53 to the cooling plate 60.

As illustrated in FIG. 1, side surfaces 36, 37 of the end portion 32 of the metal fin 30 contact side surfaces 56, 57 of the gap filler layer 50. Thus, heat can also be conducted along side conductive path SP via the side surfaces 36, 37 toward the cooling plate 60 so that heat may be better distributed across the cooling plate 60 and, thus, more quickly absorbed. A greater amount of heat may be dissipated by the cooling plate 60 over a given time. As shown in the enlarged part of FIG. 1, the portion of the gap filler layer 50 displaced by the end portion 32 of the metal fin 30 between the separation layer 53 and the first surface 51 of the gap filler layer 50 may form a recess 55. This recess 55 and the contact between the side surfaces 36, 37 of the end portion 32 of the metal fin 30 and the side surfaces 56, 57 may be provided by the pressing of the metal fin 30 on the gap filler layer 50 to partially penetrate the gap filler layer 50.

As shown in FIG. 1, the first distance D1 from the end portion 32 of the metal fin 30 to the cooling plate 60 is shorter than a second distance D2 from the end portion 32 to the first or second battery cell 10, 12. The second distance D2 may refer to the thickness of the first/second insulated layers 20/40. Thus, by having a relatively high second distance D2, thermal conductance across the battery cells 10, 12 is efficiently prevented while, due to a relatively low first distance D1, the heat can be easily dissipated via the metal fin 30 to the cooling plate 60. A third distance D3 referring to the thickness of the cell spacer S may be in the mm-scale, for example in a range of about 2 mm to about 6 mm, about 3 mm to about 5 mm, about 3.5 mm to about 4.5 mm, or about 4 mm. These distances may ensure good cell-to-cell insulation without occupying too much space.

FIGS. 2A and 2B show steps of a method of manufacturing a battery system 100 according to an embodiment of the present disclosure. The battery system 100 may refer to the battery system 100 as described above according to the various embodiments as described with respect to FIG. 1. Thus, a repetitive description is avoided and the above disclosed parts are incorporated by reference.

As can be seen in FIG. 2A and as indicated by the arrows therein, the method includes a pressing S100 of the metal fin 30 onto (or into) the gap filler layer 50. The pressing is performed until the metal fin 30 at least partially penetrates the gap filler layer 50. This final state is, for example, shown in FIG. 1, where the end portion 32 is immersed in (e.g., is buried in) the gap filler layer 50. A pressing tool may be used to apply a pressing force to the metal fin 30 to press or push the metal fin 30 into the gap filler layer 50 in a direction toward the cooling plate 60. FIG. 2A illustrates a state in which the metal fin 30 contacts the gap filler layer 50 to provide an initial contact from which the pressing on the gap filler layer 50 may be initiated.

As can be seen FIG. 2B, an intermediate pressing state is illustrated in which the metal fin 30 is pressed to push the metal fin 30 into the gap filler layer 50 toward the cooling plate 60, as indicated by the arrows. Thus, part of the material of the gap filler layer 50 is displaced to provide space for the end portion 32 of the metal fin 30. The rigid property of the metal fin 30 compared to the gap filler layer 50 allows for the metal fin 30 to be pressed into the gap filler layer 50 without deformation.

The pressing is stopped when the end portion 32 of the metal fin 30 extends toward the cooling plate 60 such that the metal fin 30 reaches a desired penetration depth or a maximum penetration depth in the gap filler layer 50. The final penetrated state is illustrated in FIG. 2B by the dashed line, which refers to the state shown in FIG. 1. The final state involves, in this example, the (thin) separation layer 53 in which the end portion 32 of the metal fin 30 is separated from the cooling plate 60 by the first distance D1. The pressing of the metal fin 30 is an easy manufacturing process without requiring advanced processing tools.

As indicated in FIG. 2A, the cell spacer S is provided prior to the step of pressing S100; for example, the first insulating layer 20 and the second insulating layer 40, with the metal fin 30 therebetween, are connected together such that the end portion 32 of the metal fin 30 protrudes with respect to the first and second insulating layers 20, 40 toward the cooling plate 60. Thus, the end portion 32 of the metal fin 30, which protrudes beyond the first and second insulating layers 20, 40, can be used to penetrate the gap filler layer 50. This is facilitated due to a rigid property of the metal of the metal fin 30 compared to the gap filler layer 50. The step of pressing S100, as described above, may involve that the battery cells 10, 12 with the spacers S are pressed together on the gap filler layer 50 to reach the final state as indicated, for example, by the dashed line in FIG. 2B.

The step of pressing S100 may be performed such that surfaces 22, 42 of the first insulating layer 20 and the second insulating layer 40 contact the first surface 51 of the gap filler layer 50 without penetrating the gap filler layer 50. Thus, only the end portion 32 of the metal fin 30 penetrates the gap filler layer 50, as explained above. The additional features as described above with respect in FIG. 1 can also be implemented in the method for which it is referred to the above description of FIG. 1.

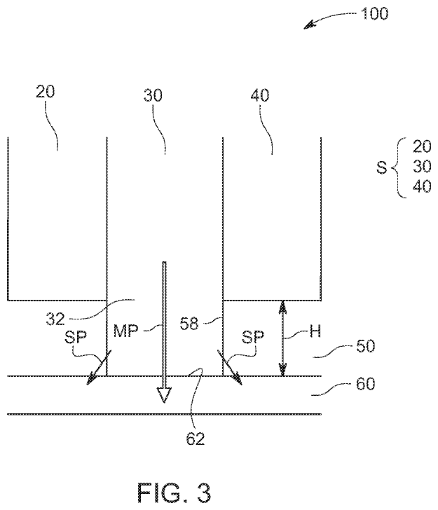

FIG. 3 is a schematic side view cross-section of a battery system 100 according to another embodiment. The differences in the embodiment shown in FIG. 3 with respect to the embodiment shown in FIG. 1 are primarily described below.

In this embodiment, the end portion 32 of the metal fin 30 directly contacts the cooling plate 60. Thus, the gap filler layer 50 has an opening 58 without gap filler material. Thus, heat can be rapidly dissipated to the cooling plate 60.

In summary, a battery system and a method of manufacturing thereof is provided in which the metal fin 30 of the cell spacer S provides a heat conducting path directed to the cooling plate 60 to rapidly dissipate heat along the metal fin 30 to the cooling plate 60 by at least partially penetrating the gap filler layer 50. Thus, because the thermal conductivity of the gap filler layer 50 is rather limited, heat can be easily thermally conducted via the end portion 32 of the metal fin 30 to the cooling plate 60 in faster manner than compared to when heat has to propagate through the bulk (e.g., the entire thickness) of the gap filler layer 50.

Thus, the cell spacer S not only acts as a cell-to-cell thermal barrier between the first and second battery cells 10, 12 due to the insulating layers 20, 40 but also provides a fast heat dissipation path for heat to be rapidly removed to the cooling plate 60 without affecting cell-to-cell thermal insulation. Therefore, stoppage or prevention of a thermal runaway is more likely achieved in the battery system 100. In addition, a relatively fast and easy manufacturing process is disclosed which can be easily implemented without requiring involved production tools.

Some Reference Signs

| | | | |
|---|---|---|---|
| 10 | first battery cell | 11 | side surface |
| 12 | second battery cell | 13 | side surface |
| S | cell spacer | | |
| 20 | first insulating layer | 22 | (contact) surface |
| 30 | metal fin | 32 | end portion |
| 34 | bottom surface | 36 | side surface |
| 37 | side surface | | |
| 40 | second insulating layer | 42 | (contact) surface |
| 50 | gap filler layer | 51 | first (contact) surface |
| 52 | second (contact) surface | 53 | separation layer |
| 55 | recess | 56 | side surface |
| 57 | side surface | 58 | opening |
| 60 | cooling plate | 62 | (contact) surface |
| H | thickness | D1 | first distance |
| D2 | second distance | D3 | third distance |
| 100 | battery system | | |
| S100 | pressing | | |

What is claimed is:

1. A battery system comprising:
a first battery cell and a second battery cell;
a housing accommodating the first and second battery cells;
a cell spacer between the first battery cell and the second battery cell, the cell spacer comprising a first insulating layer, a second insulating layer, and a metal fin between the first insulating layer and the second insulating layer;
a gap filler layer having a first surface facing the first and second battery cells and a second surface facing away from the first and second battery cells, the first and second battery cells contacting the first surface of the gap filler layer; and
a cooling plate having a surface contacting the second surface of the gap filler layer,
wherein the metal fin at least partially penetrates the gap filler layer so that an end portion of the metal fin extends toward the cooling plate.

2. The battery system according to claim 1, wherein the end portion of the metal fin protrudes beyond the first and second insulating layers in a direction toward the cooling plate.

3. The battery system according to claim 2, wherein the first insulating layer and the second insulating layer respectively have surfaces facing toward the cooling plate and contacting the first surface of the gap filler layer without penetrating the gap filler layer.

4. The battery system according to claim 1, wherein the end portion of the metal fin penetrates the gap filler layer in a direction toward the cooling plate in a range of 50% to 90% of a thickness of the gap filler layer.

5. The battery system according to claim 1, wherein a first distance from the end portion of the metal fin to the surface of the cooling plate is in a range of 0.1 mm to 0.5 mm.

6. The battery system according to claim 5, wherein the first distance is shorter than a second distance from the end portion of the metal fin to the first or second battery cell.

7. The battery system according to claim 1, wherein the first insulating layer and/or the second insulating layer comprise silica aerogel.

8. The battery system according to claim 1, wherein the end portion of the metal fin has side surfaces contacting side surfaces of the gap filler layer.

9. The battery system according to claim 1, wherein the end portion of the metal fin is spatially separated from the surface of the cooling plate by a separation layer of the gap filler layer.

10. The battery system according to claim 1, wherein the first and second battery cells are prismatic battery cells.

11. The battery system according to claim 1, wherein the first insulating layer and/or the second insulating layer comprise Mica.

12. A method of manufacturing the battery system according to claim 1, the method comprising pressing the metal fin onto the gap filler layer until the metal fin at least partially penetrates the gap filler layer so that the end portion of the metal fin extends toward the cooling plate.

13. The method of manufacturing according to claim 12, further comprising providing the cell spacer prior to the pressing of the metal fin by connecting the first insulating layer and the second insulating layer with the metal fin therebetween such that the end portion of the metal fin protrudes from the first and second insulating layers.

14. The method of manufacturing according to claim 13, wherein the pressing of the metal fin is performed such that end portions of the first insulating layer and the second insulating layer contact the first surface of the gap filler layer without penetrating the gap filler layer.

15. A vehicle comprising the battery system according to claim 1.
